(19) United States
(12) Patent Application Publication
(10) Pub. No.: US 2019/0206642 A1
(43) Pub. Date: Jul. 4, 2019

(54) INFORMATION CAPTURING DEVICE

(71) Applicant: GETAC TECHNOLOGY CORPORATION, Hsinchu County (TW)

(72) Inventor: MIN-TAI CHEN, Taipei City (TW)

(21) Appl. No.: 16/149,763

(22) Filed: Oct. 2, 2018

Related U.S. Application Data
(60) Provisional application No. 62/613,002, filed on Jan. 2, 2018.

(51) Int. Cl. H01H 19/54; H01H 36/00; H04N 5/225; G01D 5/14

(52) U.S. Cl. CPC H01H 19/54; H01H 36/00; H04N 5/76; G01D 5/145; H01H 2231/046; H04N 5/2252

(57) ABSTRACT

An information capturing device includes a housing, a rotary knob, a magnetic ring, a circuit board, a video recording unit, a control unit and a Hall sensor. The rotary knob is rotatably provided on the housing. The magnetic ring is located between the housing and the rotary knob, and includes plurality of magnetic poles, wherein magnetic poles of two different polarities are in a staggered arrangement along a ring shape. The circuit board is located in the housing. The video recording unit is provided on the circuit board and is embedded on the housing. The control unit is located in the housing and provided on the circuit board, and is coupled to the video recording unit via the circuit board. The Hall sensor is located in the housing and located on the circuit board correspondingly to the magnetic ring, and is coupled to the control unit via the circuit board.

### CROSS-REFERENCE TO RELATED APPLICATIONS

This application claims priority from U.S. Patent Application Ser. No. 62/613,002, filed on Jan. 2, 2018, the entire disclosure of which is hereby incorporated by reference.

### BACKGROUND OF THE INVENTION

### Field of the Invention

The present invention relates to an information capturing device, and more particularly to an information capturing device having a multi-option rotary knob for selecting contents for labeling information.

### Description of the Prior Art

Police and security officers conducting police tasks often need to perform video and audio recording for evidence collection in order to safekeep related evidence. Thus, police and security officers on duty can wear information capturing devices to capture media data such as ambient environment images and sounds to assist in conducting such police tasks. Further, the media data recorded by the information capturing devices can record on-site situations of events taking place, for future purposes of evidence provision and responsibility clarification.

From an aspect of utilization, in order to immediately identify to which type of events each section of recorded video information is related when recorded video and audio information is retrieved, e.g., a traffic accident or a robbery, a hotkey may be configured as a one-key setting. However, due to the vast types of events, such approach of configuring a correspondingly large number of keys as hotkeys on a panel space with a limited size is rather inconvenient.

### SUMMARY OF THE INVENTION

An information capturing device provided according to an embodiment of the present invention includes a housing, a rotary knob, a magnetic ring, a circuit board, a video recording unit, a control unit and a Hall sensor. The rotary knob is rotatably provided on the housing. The magnetic ring is located between the housing and the rotary knob, and includes a plurality of magnetic poles, wherein the magnetic poles of two different polarities are in a staggered arrangement along a ring shape. The circuit board is located in the housing. The video recording unit is provided on the circuit board and embedded on the housing. The control unit is located in the housing and provided on the circuit board, and is coupled to the video recording unit via the circuit board. The Hall sensor is located in the housing and located on the circuit board correspondingly to the magnetic ring, and is coupled to the control unit via the circuit board.

Thus, after finishing video recording by using the information capturing device, the rotary knob can be rotated to a label mode to be selected so as to label the information type of the recorded video. With the rotatable rotary knob provided, a mode for labelling can be selected by means of rotation and only one rotary knob needs to be provided on the housing. With the magnetic ring provided on the rotary knob and in conjunction with the Hall sensor, the control unit is enabled to perform determination through sensing magnetic field changes of switching between different magnetic polarities on the magnetic ring, and to further switch the label modes. Further, because control is performed in a manner of sensing magnetic field changes, the magnetic ring located outside the housing and the Hall sensor located inside the housing are enabled to perform mutual sensing without involving any additional through hole on the housing, thereby satisfying the requirement for waterproofness.

Detailed features and advantages of the present invention are described in detail in the embodiments below for a person skilled in the art to understand and accordingly implement the technical contents of the present invention. On the basis of the description, claims and drawings disclosed by the present application, a person skilled in the art can easily understand the related objects and advantages of the present invention.

### BRIEF DESCRIPTION OF THE DRAWINGS

FIG. 1 is a schematic diagram of an information capturing device according to an embodiment of the present invention;

FIG. 2 is an exploded view of an information capturing device according to an embodiment of the present invention;

FIG. 3 is a block diagram of an information capturing device according to an embodiment of the present invention; and

FIG. 4 is an exploded partial enlarged view of an information capturing device according to an embodiment of the present invention.

### DETAILED DESCRIPTION OF THE EMBODIMENTS

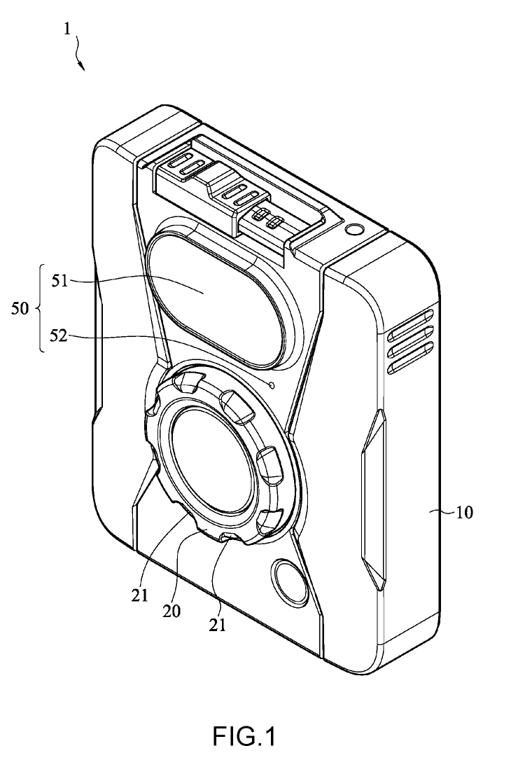

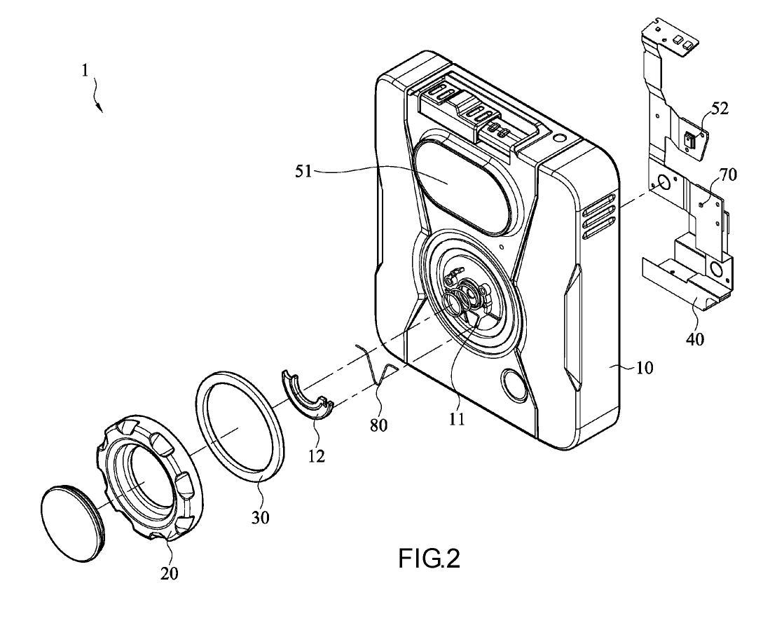

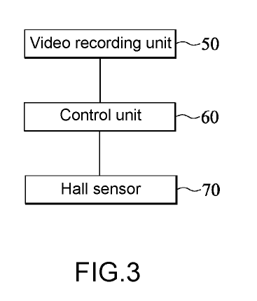

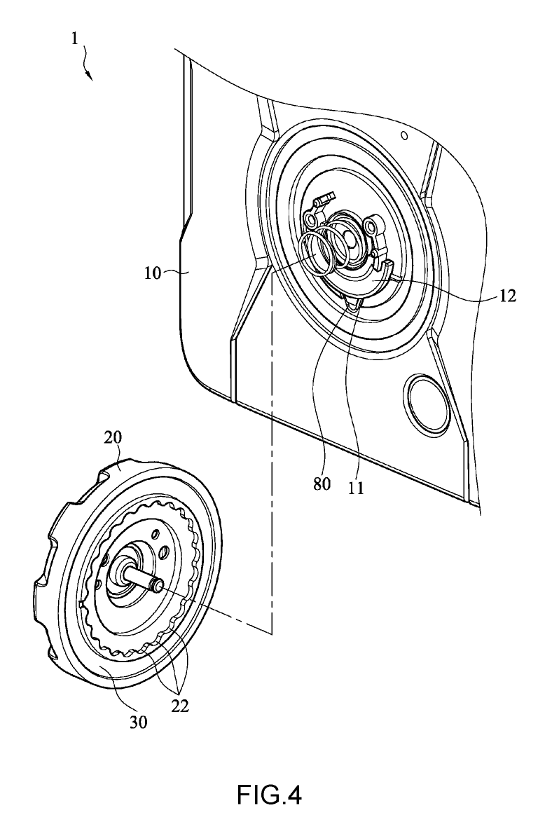

Refer to FIG. 1 to FIG. 4. FIG. 1 shows a schematic diagram of an information capturing device according to an embodiment of the present invention. FIG. 2 shows an exploded view of an information capturing device according to an embodiment of the present invention. FIG. 3 shows a block diagram of an information capturing device according to an embodiment of the present invention. FIG. 4 shows an exploded partial enlarged view of an information capturing device according to an embodiment of the present invention. An information capturing device 1 according to an embodiment includes a housing 10, a rotary knob 20, a magnetic ring 30, a circuit board 40, a video recording unit 50, a control unit 60 and a Hall sensor 70.

Known from FIG. 1 to FIG. 3, the circuit board 40 is assembled in the housing 10, and the video recording unit 50, the control unit 60 and the Hall sensor 70 are provided on the circuit board 40. The video recording unit 50 may include, for example but not limited to, a camera lens 51 and a microphone 52. The camera lens 51 and the microphone 52 are provided on the circuit board 40 and are embedded on the housing 10. The microphone 52 includes a signal processing circuit (not shown), which is capable of generating a corresponding sound signal (a digital signal) from environmental sounds (physical sound waves). The camera lens 51 is capable of image recording and capturing environmental images.

The control unit 60 is also located in the housing 10 and provided on the circuit board 40, and is coupled to the video recording unit 50 via the circuit board 40. The control unit 60, after receiving a recording activating signal, controls the video recording unit 50 to capture information, i.e., capturing environmental sounds through the microphone 52 and environmental images through the camera lens 51, and combines the environmental sounds and the environmental images into environmental information.

After completing information capturing, the information capturing device 1 of the embodiment can label the captured information, so as to promptly classify various types of information when files are later read. For example, label modes such as traffic accidents and shooting events may be set, and a corresponding label is selected after completing information capturing to immediately label various types of information, such that information can be promptly classified and found in subsequent processing.

Structural details and principle of the rotary knob for selecting a label mode are given below. Referring to FIG. 1 and FIG. 2, the rotary knob 20 is rotatably provided on the housing 10. As seen from FIG. 1, to facilitate operation and rotation of the rotary knob 20 for a user, a plurality of operation portions 21 are provided on one side surface of the rotary knob 20 away from the housing 10. At this point, the operation portions 21 are recessed structures, or may be projecting or protruding structures, dotted protrusions or rough surfaces, given that such structures bring different hand feels and provide a certain level of friction.

The magnetic ring 30 is located between the housing 10 and the rotary knob 20. In this embodiment, as seen from FIG. 4, the magnetic ring 30 is embedded inside the rotary knob 20 and is rotated along with the operation and rotation of the rotary knob 20. The magnetic ring 30 includes a plurality of magnetic poles, wherein the magnetic poles of two different polarities are in a staggered arrangement along a ring shape. For example, in this embodiment, the magnetic ring 30 consists of a plurality of N poles and a plurality of S poles in a staggered and encircling arrangement. The number of the magnetic poles on the magnetic ring 30 may be configured according to the number of adjustment options required. For example, if six label modes are needed, six magnetic poles may be provided, i.e., three sets of N poles and S poles, wherein one magnetic pole is arranged at every 60 degrees on the magnetic ring 30, forming the 360-degree magnetic ring 30 consisting of an N pole, an S pole, an N pole, an S pole, an N pole and an S pole in an encircling arrangement. It should be noted that the magnetic ring 30 is not limited to the above example.

The Hall sensor 70 provided in the housing 10 and corresponding to the magnetic ring 30, is located on the circuit board 40 and is coupled to the control unit 60 via the circuit board 40. In this embodiment, the Hall sensor 70 may be a Hall sensor capable of simultaneously sensing magnetic force changes in two axial directions. The Hall sensor 70 sense the magnetic force change in a first axis and the magnetic force change in a second axis, and outputs a sensing signal and a redirection signal to the control unit 60 according to these magnetic force changes. For example, the first axis may be parallel to the axial direction of the Hall sensor 70, and the second axis may be perpendicular to the axial direction of the Hall sensor 70; that is, the first axis is different from the second axis, and the first axis and the second axis may be in perpendicular axial directions.

When the magnetic ring 30 generates magnetic pole conversion (e.g., when an N pole changes to an S pole or an S pole changes to an N pole) or during magnetic pole conversion (e.g., an intersection of an N pole and an S pole), directions of the magnetic lines passing through the Hall sensor 70 are also changed. According to the magnetic force changes, the Hall sensor 70 generates a corresponding sensing signal and transmits the same to the control unit 60 for counting, so as to determine by how many options the rotary knob 20 has been rotated and to find the corresponding label mode. During the operation process, if the rotary knob 20 is over-rotated or rotated in reverse, the Hall sensor 70 may also output a redirection signal and a sensing signal according to the magnetic force changes detected to the control unit 60, so as to determine the current label mode to which the rotary knob 20 has been rotated.

As such, sensing of the magnetic force changes can be accomplished by one single Hall sensor 70 by providing a Hall sensor 70 capable of sensing two axial directions instead of having to provide multiple single axial direction Hall sensors.

Again referring to FIG. 2 and FIG. 4, the information capturing device 1 may further include a resilient element 80 provided in the housing 10. In this embodiment, the resilient member 80 is provided at an outer surface of the housing 10. An accommodating groove 11 for accommodating and positioning the resilient element 80 is provided on an outer surface of the housing 10. In this embodiment, as seen from FIG. 2 and FIG. 4, the resilient element 80 is in form of a V-shaped elastic metal element. Thus, the accommodating groove 11 appearing slightly V-shaped may be correspondingly provided on the outer surface of the housing 10. When the resilient element 80 is accommodated in the accommodating groove 11, a fixing element 12 may be used to fasten the resilient element 80 at a corresponding position. At this point, the resilient element 80 is permitted to elastically deform only towards an up-down direction under the limiting effect of the fixing element 12 and the accommodating groove 11, as shown in the drawings.

As seen from FIG. 4, a plurality of positioning notches 22 are provided on one side of the rotary knob 20 facing the housing 10, and one end of the resilient element 80 is selectively accommodated in one of the plurality of positioning notches 22. In this embodiment, the positioning notches 22 are also configured as V-shaped notches corresponding to the shape of the resilient element 80. Thus, when the rotary knob 20 is operated and rotated, because the positioning notch 22 is rotated along with the rotary knob 20, a side wall of the positioning notch 22 pushes the resilient element 80 to move towards an upper direction in the drawing. Upon reaching the next positioning notch 22 during the rotation, the resilient member 80 restores to an original state under the effect of the elastic restoring force, such that the V-shaped end of the resilient element 80 is again accommodated in the next positioning notch 22. During such rotation process, the deformation and restoration of the resilient element 80 also bring a user with an operating hand feel, so as to more easily rotate by one position at a time, or to learn the number of positions having rotated through the operation hand feel during the rotation process.

To enable a user to determine how many label modes the rotation has passed through the operation hand feel, the number of the positioning notches 22 may be equal to the number of magnetic poles, with each positioning notch 22 exactly corresponding to one magnetic pole on the magnetic ring 30. Further, to provide more accurate sensing, each positioning notch 22 may exactly correspond to the center of one magnetic pole. Because the direction of magnetic field at the center of the magnetic pole is more unidirectional (directly emitting towards or away from the Hall sensor 70), it can be specifically sensed that the magnetic field has changed when the rotary knob 20 is rotated to this position.

In another implementation form, the number of the positioning notches 22 may also be twice the number of the magnetic poles. In the above implementation, each positioning notch 22 may correspond to the center of one magnetic pole or the intersection of two magnetic poles. Thus, the Hall sensor 70 can generate a sensing signal according to the magnetic force changes in regard to the center of the magnetic pole and the intersection of two magnetic poles. Thus, the number of adjustment options needed can be accomplished by providing magnetic poles in one-half of the number of the corresponding label modes.

In conclusion, after finishing video recording by using the information capturing device, the rotary knob can be rotated to a label mode to be selected so as to label the information type of the recorded video. With the rotatable rotary knob provided, a mode for labelling can be selected by means of rotation and only one rotary knob needs to be provided on the housing. With the magnetic ring provided on the rotary knob and in conjunction with the Hall sensor, the control unit is enabled to perform determination through sensing magnetic field changes of switching between different magnetic polarities on the magnetic ring, and to further switch the label modes. Further, because control is performed in a manner of sensing magnetic field changes, the magnetic ring located outside the housing and the Hall sensor located inside the housing are enabled to perform mutual sensing without involving any additional through hole on the housing, thereby satisfying the requirement for waterproofness.

While the invention has been described by way of example and in terms of the preferred embodiments, it is to be understood that the invention is not limited thereto. Various modifications and similar arrangements and procedures made by a person skilled in the art without departing from the spirit of the present invention are encompassed within the scope of the present invention, and the scope of the present invention therefore should be accorded with the broadest interpretation of the appended claims.

What is claimed is:

1. An information capturing device, comprising:
a housing;
a rotary knob, rotatably provided on the housing;
a magnetic ring, located between the housing and the rotary knob, the magnetic ring comprising a plurality of magnetic poles, the magnetic poles of two different polarities in a staggered arrangement along a ring shape;
a circuit board, located in the housing;
a video recording unit, provided on the circuit board and embedded on the housing;
a control unit, located in the housing, provided on the circuit board, coupled to the video recording unit via the circuit board; and
a Hall sensor, located in the housing, located on the circuit board correspondingly to the magnetic ring, coupled to the control unit via the circuit board.

2. The information capturing device according to claim 1, wherein the Hall sensor senses a magnetic force change of a first axis and a magnetic force change in a second axis, and outputs a sensing signal and a redirection signal according to the magnetic force changes to the control unit.

3. The information capturing device according to claim 2, wherein the first axis is different from the second axis.

4. The information capturing device according to claim 1, further comprising a resilient element and provided in the housing; wherein one side of the rotary knob facing the housing comprises a plurality of positioning notches, and one end of the resilient element is selectively accommodated in one of the positioning notches.

5. The information capturing device according to claim 4, wherein the resilient element is a V-shaped elastic metal element, and each of the positioning notches is a V-shaped notch.

6. The information capturing device according to claim 4, wherein the number of the positioning notches is equal to the number of the magnetic poles.

7. The information capturing device according to claim 6, wherein each of the positioning notches corresponds to a center of one of the magnetic poles.

8. The information capturing device according to claim 4, wherein the number of the positioning notches is twice the number of the magnetic poles.

9. The information capturing device according to claim 8, wherein each the positioning notches corresponds to a center of one of the magnetic poles or an intersection of two adjacent magnetic poles.

10. The information capturing device according to claim 1, wherein the one side of the rotary knob away from the housing comprises a plurality of operation portions.
